(19) United States
(12) Patent Application Publication
(10) Pub. No.: US 2005/0019462 A1
(43) Pub. Date: Jan. 27, 2005

(54) Edible tongue tattoo

(76) Inventor: Ki Kwan (David) Chu, Tsuen Wan (HK)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/926,611

(22) Filed: Aug. 26, 2004

Related U.S. Application Data
(62) Division of application No. 10/271,187, filed on Oct. 15, 2002, now abandoned.

(51) Int. Cl. A23P 1/00

(52) U.S. Cl. 426/383

(57) ABSTRACT

A device for transferring an image to a tongue includes a sheet of saliva-dissolvable material, and an image pattern formed on the sheet. The image pattern includes a coloration material, which interacts with saliva for leaving an image on the tongue.

### RELATED APPLICATION DATA

This application is a divisional of copending application Ser. No. 10/271,187, filed Oct. 15, 2002 and incorporated herein by reference.

### FIELD OF THE INVENTION

The present invention generally relates to novelty items and, more particularly, to an edible tattoo and method for application on a tongue of an individual.

### BACKGROUND OF THE INVENTION

Non-permanent tattoos may be presently purchased at retail stores. In some instances tattoos may be included as promotional materials for enhancing sales of a different product, such as, for example, candy or cereal. Non-permanent tattoos have gained popularity recently and are presently employed, not only as a novelty item, but also as a fashion accessory instead of or in addition to jewelry.

These non-permanent tattoos typically require the tattoo be placed on an area of dry skin and wet to transfer the latex or other polymeric material to the surface of the skin. These tattoos wear off due to abrasion and do not adhere well when the skin is wet. Other types of non-permanent tattoos include ink tattoos applied to the surface of the skin. These tattoos are easily washed off and smudge.

Accordingly, a need exists for a novelty tattoo, which may be applied to a wet area of the body such as the tongue. In addition, the tattoo is preferably edible.

### SUMMARY OF THE INVENTION

A device for transferring an image to a tongue includes a sheet of saliva-dissolvable material, and an image pattern formed on the sheet. The image pattern includes a coloration material, which interacts with saliva for leaving an image on the tongue.

In other embodiments, the sheet preferably includes flavoring and coloring, and preferably includes at least one of sugar and cornstarch. The coloration material preferably dissolves in saliva at a greater rate than the material of the sheet, and the coloration material preferably includes a dye, which dissolves in saliva at a rate less than the coloration material.

A device for applying an edible tattoo includes a sheet of a solution-dissolvable material, and an image pattern formed on the sheet. The image pattern includes a coloration material, which interacts with the solution for leaving behind an image on a body part.

In other embodiments, the solution includes saliva and the sheet and the image pattern are dissolvable in saliva. The sheet preferably includes at least one of sugar and cornstarch. The tattoo is preferably applied to a tongue. The solution may include water and the sheet and the image pattern may be dissolvable in water. The coloration material preferably dissolves at a greater rate than the material of the sheet, and the coloration material preferably includes a dye, which dissolves in saliva at a rate less than the coloration material. The sheet may be edible or not edible.

A method for applying an edible tattoo to a tongue includes providing a sheet of a solution-dissolvable material, and an image pattern formed on the sheet. The image pattern includes a coloration material, which interacts with the solution for leaving behind an image. The image pattern on the sheet is contacted to a tongue for a period of time to transfer the image pattern to the tongue.

In other methods, the step of providing may include providing an indicator for aligning the image on the tongue. The step of ingesting the sheet may be included. The period of time may include at least 2 seconds. The step of providing a dispenser for dispensing one or more sheets may be included.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a top view of an edible sheet for placing an image or tattoo on a surface in accordance with the present invention;

FIG. 2A is a schematic diagram showing the placement of an edible sheet on a body part or tongue in accordance with the present invention;

FIG. 2B is a schematic diagram showing the placement of a non-edible applicator on a body part or tongue in accordance with the present invention;

FIG. 3 is perspective view of a tongue with a tattoo/pattern image formed thereon in accordance with the present invention;

FIG. 4 is a perspective view of an illustrative storage compartment for edible sheets in accordance with the present invention; and

FIG. 5 is a flow diagram for a method of applying a tattoo in accordance with the present invention.

It should be understood that the drawings are for purposes of illustrating the concepts of the invention and are not necessarily the only possible configuration for illustrating the invention.

### DETAILED DESCRIPTION OF THE INVENTION

The present invention provides an edible tattoo and includes an apparatus for transferring the tattoo to a tongue of a user. The tattoo then remains on the tongue of the user temporarily. The present invention also provides a method for applying the tattoo to a tongue and a method for manufacturing the apparatus for transferring the tattoo to the tongue of a user.

The present invention will be illustratively described in terms of a tongue tattoo; however the present invention is broader and may include tattoo placement on other areas of the body. In addition, the apparatus for transferring the tattoo may take different forms as well.

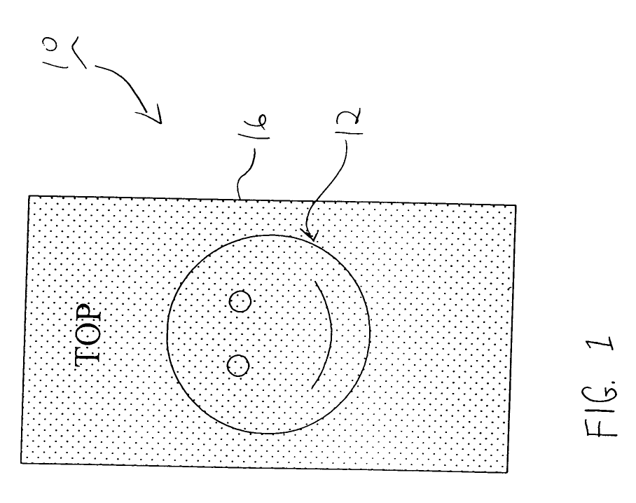

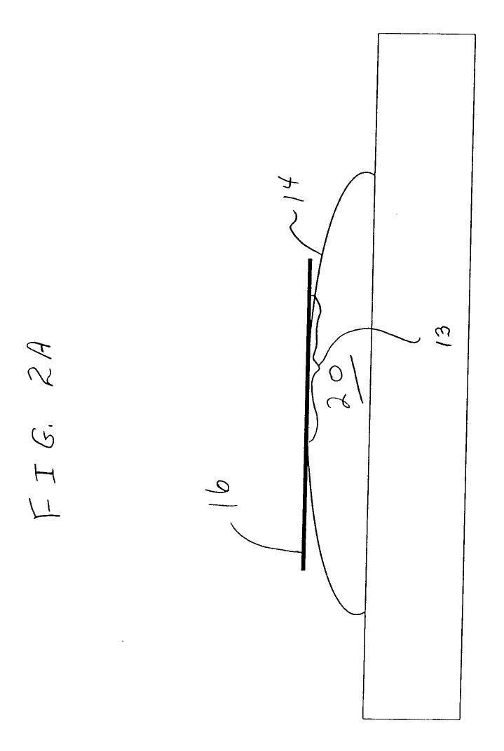

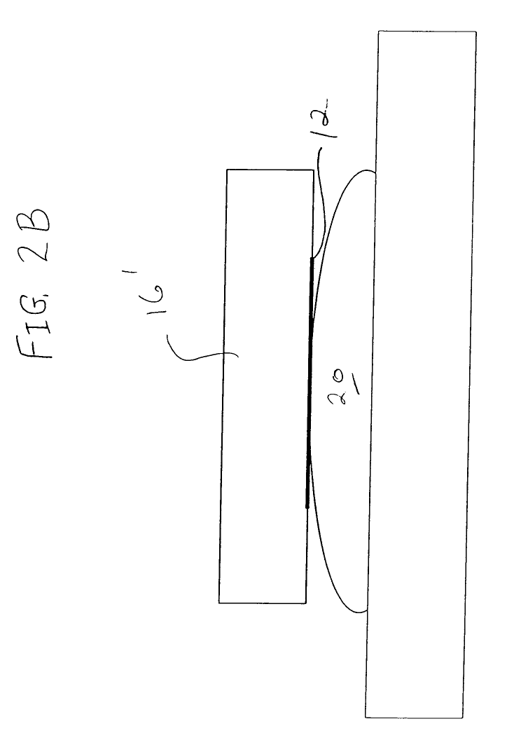

Referring now in specific detail to the drawings in which like reference numerals identify similar or identical elements throughout the several views, and initially to FIG. 1, an edible tattoo 10 is comprised of a tattoo or image pattern 12 to be transferred to a surface 14 (FIG. 2), which is preferably wet and more preferably wet with saliva. Pattern 12 is placed on a sheet 16. Sheet 16 may include a thin sheet of, for example, rice paper or sugar fibers. In one embodiment, both sheet 16 and pattern 12 include an edible material. Edible material of sheet 16 preferably includes cornstarch, sugar, aspartame or sugar substitute, which easily dissolves in saliva. In an alternate embodiment, materials may be employed for sheet 16 and pattern 12 which are water-soluble. In another embodiment, a non-edible material may be employed for sheet 16, and pattern 12 may be transferred by wetting and then removing sheet 16. A plurality of images and different types of images may be employed for image pattern 12.

Pattern 12 may include one or more colors stamped, screen-printed or otherwise formed onto sheet 16 by an edible dye/ink application process. Pattern 12 and/or sheet 16 may include artificial or natural colors and may include artificial and/or natural flavors. Sheet 16 may be approximately ¼ inch wide by ½ inch long and preferably a few thousandths of an inch thick (e.g., paper thin). These dimensions are illustrative and other dimensions are also contemplated.

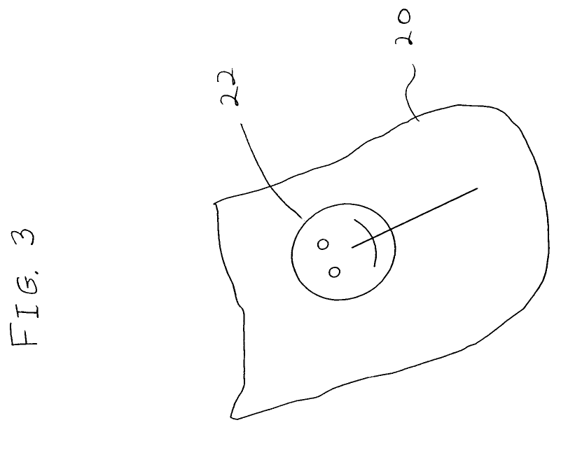

Referring to FIG. 2A, to transfer an image of pattern 12 to a body part, saliva is preferably employed. In a preferred embodiment, sheet 16 is placed on surface 14 of a tongue 20 or other body part of a user at a position 13 where a pattern image 12 is desired. The saliva on the tongue dissolves the material of pattern 12 to permit the dye/color of pattern to stain the tongue 20. The dye/color in pattern 12 is much less soluble in saliva than the matrix (or coloration material) of starches/sugars, which carry the dye/color in its “dry” pre-use state. In this way, a tattoo or pattern image 22 remains for a time on the tongue 20 of the user as depicted in FIG. 3. In preferred embodiments, tattoo or pattern image 22 remains on the tongue for at least 2 minutes, although greater or less time is also contemplated. Then, the ink/dye breaks down releasing additional flavor in the mouth of the user.

Pattern 12 may also be applied to other body parts by licking or otherwise applying saliva to sheet 16 and pattern 12 and applying pattern 12 to the area to be stained by pattern image 22. If image 22 is applied by an edible sheet or applicator 16, then the user may eat sheet 16. For best results the tongue should be maintained flat and the mouth open during the tattoo transfer process.

FIG. 2B shows a non-edible applicator 16′ which may be licked by a user to transfer the edible coloring to a body part to transfer the pattern image 22 thereto.

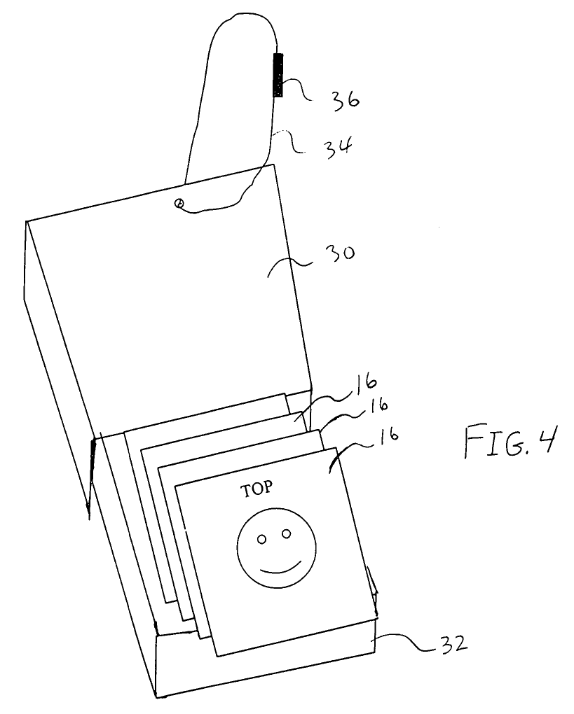

Referring to FIG. 4, a storage compartment 30 may be employed to store and/or transport tattoo sheets 16. Compartment 30 may include a sliding drawer 32 configured to receive sheets 16. Sheets 16 may be stored flat, dispensed from a roll or connected to permit pullout from an orifice one sheet at a time. Compartment 30 may be formed from a polymeric material and be formed into different shapes, such as e.g., a tongue, a heart, a character, or any object or shape. In addition, compartment 30 may be configured with connection device 34, such as a strap, chain, string or other mechanism to permit compartment to be attached to a user's effects or person. Connection device 34 may include an adjustment mechanism 36 to adjust the length of connection device 34. Other dispensers and dispensing methods are also contemplated.

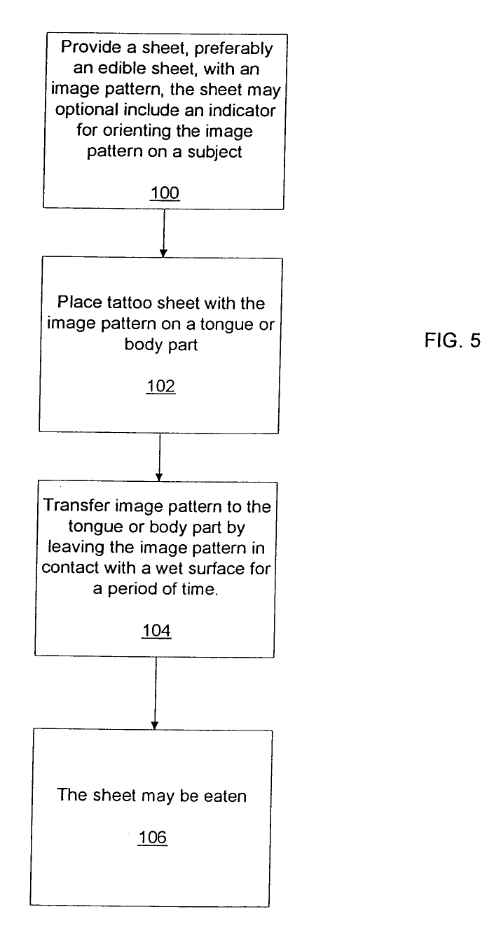

Referring to FIG. 5, a method for applying a tongue tattoo in accordance with the present invention may include the following steps. In block 100, a direction and side indicator is provided on an edible sheet. The indicator denotes to a user the orientation and side of the sheet to place on the tongue to properly position the tattoo pattern on the tongue or body part. In block 102, the tattoo sheet is placed on the tongue in accordance with the indicator. The pattern is placed in contact with the tongue or a wet surface, where the surface is wet with a liquid capable of breaking down the pattern image carrier to release the dye or color, which will form the tattoo image on the tongue or body part.

In block 104, the pattern is transferred to the tongue by waiting preferably about 5 seconds, and more preferably about 2-4 seconds, with the pattern in contact with the tongue. The mouth of the user should preferably remain open during the wait time. The coloration material of the pattern is dissolved releasing color/dye therefrom, which stains the tongue in the image of the pattern. It is to be understood that the pattern carrier (coloration material of pattern) preferably dissolves faster in saliva then sheet 16. In this way, the image is transferred before the sheet can dissolve. Increased solubility may be attributable to a larger surface area of the coloration material of pattern 12 due to surface roughness. For example, the printing of pattern 12 includes a higher roughness than sheet 16 and therefore can dissolve faster. In addition, different mixtures of saliva-soluble (or water soluble) materials may be employed to provide a solubility difference between pattern 12 and sheet 16. The dye included in the coloration material preferable dissolves at a rate that is less than the pattern carrier. In this way, the dye leaves a pattern on the tongue of the user after the image has been transferred. Later, as the dye dissolves additional flavor may be released.

In block 106, the user may now eat the sheet (if the sheet or applicator is edible). The user has a tattoo pattern temporarily placed on their tongue (or body part) in accordance with the present invention.

An illustrative method for manufacturing a preferred embodiment of the present invention will now be described. The ingredients are mixed for the sheets, and then cooked. The sheets are first manufactured in larger sheets or rolls for ease of manufacture. The sheets or rolls are flavored and colored during the mixing process or after the rolls are formed. Sheets are then cut from the rolls for individual tattoos and then printed with patterns for the tattoos. The sheets, containers and packaging are disinfected. Next, the sheets are packaged into the containers and then packaged into foil/blister and blister card packaging. Other types of packaging may also be employed. The steps above may be modified and ordered in a plurality of ways depending on the desired results.

Having described preferred embodiments for an edible tongue tattoo (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for applying an edible tattoo to a tongue, comprising the steps of:
providing a sheet of a solution-dissolvable material, and an image pattern formed on the sheet, the image pattern including a coloration material which interacts with the solution for leaving behind an image; and
contacting image pattern on the sheet to a tongue for a period of time to transfer the image pattern to the tongue.

2. The method as recited in claim 1, wherein the step of providing includes providing an indicator for aligning the image on the tongue.

3. The method as recited in claim 1, further comprising the step of ingesting the sheet.

4. The method as recited in claim 1, wherein the period of time includes at least 2 seconds.

5. The method as recited in claim 1, further comprising the step of providing a dispenser for dispensing one or more sheets.

6. The method as recited in claim 1, wherein the sheet is edible.

7. A method for applying an edible tattoo to a tongue, comprising the steps of:
providing a sheet of a saliva dissolvable material, and an image pattern formed on the sheet, the image pattern including a coloration material which interacts with the saliva for staining an image onto the tongue;
contacting the image pattern on the sheet to the tongue for a period of time to stain the image pattern onto the tongue; and
maintaining the image on the tongue for a duration of time.

8. The method as recited in claim 7, wherein the step of providing includes providing an indicator for aligning the image on the tongue.

9. The method as recited in claim 7, further comprising the step of ingesting the sheet.

10. The method as recited in claim 7, wherein the period of time includes at least 2 seconds.

11. The method as recited in claim 7, further comprising the step of providing a dispenser for dispensing one or more sheets.

12. The method as recited in claim 7, wherein the duration of time includes at least 2 minutes.

13. The method as recited in claim 7, wherein the sheet is edible.

14. A method for forming a stained image on a tongue, comprising the steps of:
providing a sheet of material for placement on a surface of the tongue;
providing an image pattern formed on the sheet, the image pattern including a coloration material comprising a dye; wherein the coloration material interacts with saliva on the tongue to allow the dye to stain the tongue to form the stained image when the sheet is placed thereon; and
contacting the image pattern on the sheet to the tongue for a period of time to stain the image pattern onto the tongue; and
maintaining the image on the tongue for a duration of time.

15. The method as recited in claim 14, wherein the duration of time includes at least 2 minutes.

16. The method as recited in claim 14, wherein the sheet is edible.
